(19) United States
(12) Patent Application Publication
(10) Pub. No.: US 2011/0009307 A1
(43) Pub. Date: Jan. 13, 2011

(54) Laundry Detergent Composition Comprising Low Level of Sulphate

(76) Inventors: Alan Thomas Brooker, Newcastle upon Tyne (GB); Mark Forrest, Northumberland (GB); Kim Keltie, Argyll (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/823,208

(22) Filed: Jun. 25, 2010

Related U.S. Application Data
(60) Provisional application No. 61/224,165, filed on Jul. 9, 2009.

(51) Int. Cl. C11D 1/83

(52) U.S. Cl. 510/351

(57) ABSTRACT

A laundry detersive composition. The composition has (i) from about 1 wt % to about 60 wt % detergent surfactant; (ii) from about 0 wt % to about 10 wt % zeolite builder; (iii) from about 0 wt % to about 10 wt % phosphate builder; (iv) from about 0 wt % to about 10 wt % inorganic sulphate salt and (v) balance detergent ingredients.

### CROSS REFERENCE TO RELATED APPLICATION

This application claims the benefit of U.S. Provisional Application No. 61/224,165, filed Jul. 9, 2009.

### FIELD OF THE INVENTION

The present invention relates to solid laundry detersive compositions. More specifically, the present invention relates to solid laundry detersive compositions comprising low level of sulphate.

### BACKGROUND OF THE INVENTION

A solid laundry detersive composition generally contains a builder. A builder is an agent used to assist the washing performance of the surfactant. Builders include zeolite, inorganic salt, organic salt, and so on. Some laundry detersive compositions contain additional components such as a perfume, an enzyme, a dye, etc. The anionic surfactant's tendency to complex with free cations in the hard water wash liquor in such a manner as to precipitate out of solution is mitigated by the presence of builders, such as zeolite builders and phosphate builders, which have a high binding constant with free cations such as calcium cations and magnesium cations. These builders sequester free calcium and magnesium cations and reduce the formation of these undesirable complexes.

However, zeolite builders are water-insoluble and their incorporation in laundry detersive compositions leads to poor dissolution of the laundry detersive composition, and can lead to undesirable residues being deposited on the fabric. In addition, detergent compositions that contain high levels of zeolite builder form undesirable cloudy wash liquors upon contact with water. Whereas phosphate builders allegedly do not have favourable environmental profiles and their use in laundry detersive compositions is becoming less common; for example, due to phosphate legislation in many countries.

Recent development in the laundry detergent area has been to significantly reduce or even remove both zeolite and phosphate builders from the detergent product. Formulators have designed hardness tolerant surfactant systems that do not readily precipitate out of solution in the presence of cations such as calcium and magnesium.

Whilst the cleaning performance of low builder laundry detergents are good, there was still a need to further improve the whiteness performance and enzyme activity of these formulations. The inventors have found that sodium sulphate, in the absence of zeolite and phosphate builders, can form calcium sulphate in the wash liquor, which can deposit on the fabric. The inventors believe this may impede the whiteness profile of the detergent product. In addition, the consumption of free calcium cations due to the formation of calcium sulphate reduces the enzyme deposition onto the fabric: free calcium cations aid enzyme deposition on the fabric. Furthermore, high electrolyte activity can hinder enzyme deposition on fabric. The inventors have found that by significantly reducing, or even removing, sodium sulphate from a low built laundry detergent composition, the enzyme deposition onto fabric is improved.

### SUMMARY OF THE INVENTION

The present invention relates to a laundry detergent composition defined by the claims.

### DETAILED DESCRIPTION OF THE INVENTION

### Laundry Detergent Composition

The present invention relates to a solid laundry detersive composition. The laundry detergent composition contains a solid laundry detersive composition containing: (i) from about 1 wt % to about 60 wt % detersive surfactant; (ii) from about 0 wt % to about 10 wt % zeolite builder; (iii) from about 0 wt % to about 10 wt % phosphate builder; (iv) from about 0 wt % to about 10 wt % inorganic sulphate salt and (v) balance detergent ingredients.

The laundry detersive composition is suitable for use in the laundering of fabrics. The detergent composition contains a low level of inorganic sulphate salt.

Accordingly, it may be preferred if the composition contains low levels of, or substantially no deliberately added inorganic sulphate salt. The composition may contain from about 0 wt % to about 10 wt %, from about 0 wt % to about 9 wt % or from about 0 wt % to about 8 wt % inorganic sulphate salt to minimize the negatives associated with the presence of carbonate in the composition. Preferably, the composition contains from about 0 wt % to about 10 wt %, from about 0 wt % to about 9 wt % or from about 0 wt % to about 8 wt % sodium sulphate.

Reduced level of inorganic sulphate salt may diminish the formation of calcium sulphate in the wash liquor. As a result, calcium sulphate less likely precipitates and deposits on the fabric. Without intending to be bound by theory, free calcium cations aid enzyme deposition on the fabric. The formulation herein assists remaining calcium cations to influence enzymes. Furthermore, reduced level of inorganic sulphate salt may provide a benefit that the electrolytes in the wash liquor, including enzymes that are essentially electrolytes in an aqueous solution, are less attracted to each other and the enzymes can more readily deposit on the fabric.

It may be even possible for the composition to contain no deliberately added inorganic sulphate salts at all, i.e., the composition may be substantially free from inorganic sulphate salts; this is to maximize the fabric deposition profile of materials like enzymes.

In one embodiment, the composition herein is a granular laundry detersive composition.

In one embodiment, the composition herein may further contain an enzyme selected from the group consisting of lipase, protease, amylase, mannose, cutinase, bleaching enzymes, pectate lyase, cellulase and a mixture thereof.

In one embodiment, the inorganic sulphate salt is selected from the group consisting of sodium sulphate, potassium sulphate, magnesium sulphate, and a mixture thereof. Sodium sulphate is more preferable.

The detergent composition can be in the form of a solid; such as in form of free-flowing particles or in the form of a tablet. The detergent composition may be in the form of free-flowing particles such as agglomerates, extrudates, spray-dried particles, noodles, needles, flakes and combinations thereof. The composition may be a granular laundry detergent composition. The detergent composition in free-flowing particulate form typically has a bulk density of from about 450 g/l to about 1,000 g/l, preferred low bulk density detergent compositions have a bulk density of from about 550 g/l to about 650 g/l and preferred high bulk density detergent compositions have a bulk density of from about 750 g/l to about 900 g/l. During the laundering process, the composition is typically contacted with water to give a wash liquor having a pH of from about 7 to about 11, or from about 8 to about 10.5.

The composition may be made by any suitable method including agglomeration, spray-drying, extrusion, mixing, dry-mixing, liquid spray-on, roller compaction, spheronisation or any combination thereof.

The composition herein may contain the following ingredients.

### Surfactant

The composition herein contains from about 1 wt % to about 60 wt %, from about 2 wt % to about 55 wt %, from 3 wt % to about 50 wt %, or from about 4 wt % to about 40 wt % detersive surfactant. The detersive surfactant may contain an anionic surfactant, a nonionic surfactant, a cationic surfactant, a zwitterionic surfactant, or any mixture thereof. The surfactant may be amphoteric, and have a ionic charge dependant on the pH of a typical wash liquor.

### Anionic Surfactant

The composition may contain an anionic surfactant. Preferably the composition may comprise from 1 wt % to 40 wt %, preferably from 2 wt % to 30 wt %, or from 5 wt % to 20 wt % anionic surfactant. The anionic surfactant can be selected from the group consisting of: C₁₀-C₁₈ alkyl benzene sulphonates (LAS), preferably linear C₁₀-C₁₃ alkyl benzene sulphonate; C₁₀-C₂₀ primary, branched-chain, linear-chain and random-chain alkyl sulphates (AS), preferred are linear alkyl sulphates, typically having the following formula:

CH₃(CH₂)ₓCH₂—OSO₃⁻M⁺,

wherein, M is hydrogen or a cation which provides charge neutrality, preferred cations include sodium and ammonium cations, wherein x is an integer of at least 7, preferably at least 9, highly preferred are linear or branched, substituted or unsubstituted C₁₂-C₁₈ alkyl sulphate; C₁₀-C₁₈ secondary (2,3) alkyl sulphates, typically having the following formulae:

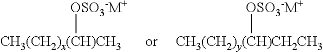

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof. Preferred anionic surfactants are: linear or branched, substituted or unsubstituted, C₁₂₋₁₈ alkyl sulphates; and linear or branched, substituted or unsubstituted, C₁₀₋₁₃ alkylbenzene sulphonates, preferably linear C₁₀₋₁₃ alkylbenzene sulphonates; and mixtures thereof.

Another preferred anionic surfactant is a C₈₋₂₄ alkylalkoxylated sulphate, preferably an C₈₋₂₄ alkylethoxylated sulphate, preferably having an average degree of ethoxylation of 1 to 5.

The anionic surfactant may be structurally modified in such a manner as to cause the anionic surfactant to be more calcium tolerant and less likely to precipitate out of the wash liquor in the presence of free calcium ions. This structural modification could be the introduction of a methyl or ethyl moiety in the vicinity of the anionic surfactant's head group, as this can lead to a more calcium tolerant anionic surfactant due to steric hindrance of the head group, which may reduce the anionic surfactant's affinity for complexing with free calcium cations in such a manner as to cause precipitation out of solution. Other structural modifications include the introduction of functional moieties, such as an amine moiety, in the alkyl chain of the anionic surfactant; this can lead to a more calcium tolerant anionic surfactant because the presence of a functional group in the alkyl chain of an anionic surfactant may minimise the undesirable physicochemical property of the anionic surfactant to form a smooth crystal structure in the presence of free calcium ions in the wash liquor. This may reduce the tendency of the anionic surfactant to precipitate out of solution.

The anionic surfactant may be in particulate form, such as an agglomerate, a spray-dried powder, an extrudate, a bead, a noodle, a needle or a flake. The anionic surfactant, or at least part thereof, may be in a co-particulate admixture with a non-ionic surfactant, this co-particulate admixture may be in spray-dried form. The anionic surfactant, or at least part thereof, may be in agglomerate form; the agglomerate may contain at least about 20 wt %, of the agglomerate, of an anionic surfactant, or from about 20 wt % to about 65 wt %, of the agglomerate, of an anionic surfactant. Part of the anionic surfactant may be in the form of a spray-dried powder (e.g. a blown powder), and part of the anionic surfactant may be in the form of a non-spray-dried powder (e.g. an agglomerate, or an extrudate, or a flake). A linear alkylbenzene sulphonate may be in a co-particulate admixture with soap, this co-particulate admixture may be in spray-dried form.

### Non-Ionic Detersive Surfactant

The composition herein may contain non-ionic surfactant. The composition herein may contain from about 0.1 wt % to about 15 wt %, from about 0.5 wt % to about 10 wt %, or from about 1 wt % to about 6 wt % non-ionic surfactant.

The non-ionic surfactant can be selected from the group consisting of: C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, or propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEₓ, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic surfactant could be an alkyl polyglucoside and/or an alkyl alkoxylated alcohol. The non-ionic surfactant may be a linear or branched, substituted or unsubstituted C₈₋₁₈ alkyl ethoxylated alcohol having an average degree of ethoxylation of from 1 to 10.

The non-ionic surfactant not only provides additional greasy soil cleaning performance but may also increase the anionic surfactant activity by making the anionic surfactant less likely to precipitate out of solution in the presence of free calcium cations. The weight ratio of anionic surfactant to non-ionic surfactant may be in the range of from about 0.5:1 to about 20:1, from about 0.5:1 to about 10:1, or from about 0.5:1 to about 6:1.

The non-ionic surfactant, or at least part thereof, can be incorporated into the composition in the form of a liquid spray-on, wherein the non-ionic surfactant, or at least part thereof, in liquid form (e.g. in the form of a hot-melt) is sprayed onto the remainder of the composition. The non-ionic surfactant, or at least part thereof, may be in particulate form, and the non-ionic surfactant, or at least part thereof, may be dry-added to the remainder of the composition. The non-ionic surfactant, or at least part thereof, may be in the form of a co-particulate admixture with a solid carrier material, such as carbonate salt, inorganic sulphate salt, burkeite, silica or any mixture thereof.

The non-ionic surfactant, or at least part thereof, may be in a co-particulate admixture with either an anionic surfactant or a cationic surfactant. However the non-ionic surfactant, or at least part thereof, may not in a co-particulate admixture with both an anionic surfactant and a cationic surfactant. The non-ionic surfactant, or at least part thereof, may be agglomerated or extruded with either an anionic surfactant or a cationic surfactant. The non-ionic surfactant, or at least part thereof, may be in spray-dried powder form, optionally the non-ionic surfactant, or at least part thereof, may be spray-dried with an anionic surfactant. The non-ionic surfactant, or at least part thereof, may be in a co-particulate admixture with soap, this co-particulate admixture may be in non-spray-dried form, such as an extrudate or an agglomerate.

### Cationic Detersive Surfactant

The composition may contain from about 0 wt % to about 6 wt, from about 0.5 wt % to about 4 wt %, from about 1 wt % to about 3 wt %, or from about 1 wt % to about 2 wt % cationic surfactant.

Suitable cationic surfactants are alkyl pyridinium compounds, alkyl quaternary ammonium compounds, alkyl quaternary phosphonium compounds, and alkyl ternary sulphonium compounds. The cationic surfactant can be selected from the group consisting of: alkoxylate quaternary ammonium (AQA) surfactants as described in more detail in U.S. Pat. No. 6,136,769; dimethyl hydroxyethyl quaternary ammonium compounds as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and a mixture thereof. Preferred cationic surfactants are quaternary ammonium compounds having the general formula:

(R)(R¹)(R²)(R³)N⁺X⁻

wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include halides (such as chloride), sulphate and sulphonate. Preferred cationic surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

The cationic surfactant may provide additional greasy soil cleaning performance. However, the cationic surfactant may increase the tendency of the anionic surfactant to precipitate out of solution. The cationic surfactant and the anionic surfactant may be present in the composition in the form of separate particles. This minimises any effect that the cationic surfactant may have on the undesirable precipitation of the anionic surfactant, and also ensures that upon contact with water, the resultant wash liquor is not cloudy. The weight ratio of anionic surfactant to cationic surfactant may be in the range of from about 5:1 to about 25:1, from about 5:1 to about 20:1, from about 6:1 to about 15:1, from about 7:1 to about 10:1, or from about 8:1 to about 9:1.

### Builder

The composition may contain one or more detergent builders or builder systems. Builders include, for example, zeolite builder, phosphate builder.

### Zeolite Builder

The composition contains from about 0 wt % to about 10 wt %, from about 0 wt % to about 8 wt %, or from about 0 wt % to about 6 wt %. The composition may be free from deliberately added zeolite builder; i.e., may be substantially free from zeolite builder. This may be preferred if it is desirable for the composition to be very highly soluble. In addition, this is highly preferred if the composition, upon contact with water, is to form a transparent wash liquor. Zeolite builders include zeolite A, zeolite X, zeolite P and zeolite MAP.

### Phosphate Builder

The composition contains from about 0 wt % to about 10 wt %, from about 0 wt % to about 8 wt %, from about 0 wt % to about 6 wt %, or from about 0 wt % to about 1 wt % phosphate builder. In one embodiment, the composition may be free from deliberately added phosphate builder, i.e., may be substantially free from phosphate builder. This may be preferred if it is desirable for the composition to have a very good environmental profile. Phosphate builders typically include sodium tripolyphosphate and sodium hydroxyethylidene diphosphonate.

### Other Builders

The composition herein may contain other builders in addition to the zeolite builder and/or phosphate builder as described above. In one embodiment, water-soluble adjunct builders may be used. Adjunct builders may include sodium carbonate, citric acid and/or water-soluble salts thereof including sodium citrate; sulphamic acid and/or water-soluble salts thereof; polymeric polycarboxylates such as co-polymers of acrylic acid and maleic acid, or polyacrylate. The composition may contain very low levels of water-insoluble builders, such as zeolite A, zeolite X, zeolite P, and zeolite MAP, whilst comprising relatively high levels of water-soluble adjunct builders, such as sodium carbonate, sulphamic acid and citric acid.

The weight ratio of sodium carbonate to zeolite builder may be at least about 5:1, at least about 10:1, at least about 15:1, at least about 20:1 or at least about 25:1.

### Balance Detergent Ingredients

The composition further contains balance detergent ingredients, such as enzymes, silicate salts, polymeric carboxylates, solid dispersants, inorganic sulphate salts, and other adjunct components.

### Enzyme

The composition herein contains enzymes, e.g., protease, amylase, lipase, cellulose, mannanase, pectate lyase, bleaching enzymes, and the like.

The composition herein may contain a protease, for instance, the composition contains at least about 11 mg, at least about 15 mg, at least about 20 mg, or at least about 30 mg of active protease per 100 g of composition. The protease may contain a calcium binding site. The protease may show improved stability and/or activity in the presence of high levels of free calcium cations present in the wash liquor. By incorporating the protease into the composition, the cleaning performance of the composition is improved, and any reduction in the cleaning performance of the composition due to the low levels of, or lack of, zeolite builders and phosphate builders, which lead to a reduction in the anionic surfactant activity, is mitigated by the increased stability and/or activity of the protease. Preferred proteases include: subtilisins from Bacillus [e.g. subtilis, lentus, licheniformis, amyloliquefaciens (BPN, BPN′), alcalophilus] that are sold under the trade names Esperase®, Alcalase®, Everlase® and Savinase® supplied by Novozymes; proteases supplied by Genencor under the tradenames FN2®, FN3® and FN4®; and BLAP and/or variants thereof. Suitable proteases are described in more detail in EP 130 756, WO 91/06637, WO 95/10591 and WO 99/20726.

The composition may also contain amylase, for example, in an amount of at least about 4 mg, at least about 6 mg, at least about 10 mg, at least about 15 mg, at least about 20 mg, or about 30 mg of active amylase per 100 g of the total composition. The amylase may contain a calcium binding site. Analogous to the protease, the amylase may also show improved stability and/or activity, especially stability, in the presence of high levels of free calcium cations present in the wash liquor. Thus, incorporation of amylase into the composition may improve the cleaning performance. The amylases include: amylases supplied by Novo Industries A/A under the tradenames Natalase®, Duramyl®, Termamyl®, Ban®, Fungamyl®; amylases supplied by Genencor under the tradename Purafect Ox Am®; and mixtures thereof. The amylase can be an α-amylase or a β-amylase. Suitable amylases are described in more detail in WO 94/02597 and WO 96/23873.

The composition may also contain lipase, for example, in an amount of at least about 5 mg, at least about 7 mg, at least about 10 mg, at least about 15 mg, at least about 20 mg, or at least about 30 mg of active lipase per 100 g of composition. The lipase may contain a calcium binding site. Analogous to both the protease and the amylase, the lipase may also show improved stability and/or activity, especially activity, in the presence of high levels of free calcium cations present in the wash liquor. The incorporation of lipase into the composition improves the cleaning performance. Preferred lipases include those produced by Pseudomonas and Chromobacter groups. Preferred lipases are supplied by Novozymes under the tradenames. Lipolase®, Lipolase Ultra®, Lipoprime® and Lipex®. Other suitable lipases are cutinases and esterases.

The composition may also contain other enzymes such as: cellulases, including bacterial or fungal cellulases such as cellulases produced by Humicola insolens, and in particular cellulases supplied by Novo Industries A/A under the tradenames Carezyme®, Endo A®, other suitable cellulases are the EGIII cellulases from Trichoderma longibrachiatum; carbohydrases, including mannanase such as that described in more detail in U.S. Pat. No. 6,060,299, pectate lyase such as that described in more detail in WO 99/27083, cyclomaltodextringlucanotransferase such as that described in more detail in WO 96/33267, xyloglucanase such as that described in more detail in WO 99/02663; bleaching enzymes such as peroxidases, laccases, oxygenases (e.g. catechol 1,2 dioxygenase), lipoxygenase that is described in more detail in WO 95/26393, and non-heme haloperoxidases.

The composition may also contain other enzymes such as: cellulases, including bacterial or fungal cellulases such as cellulases produced by Humicola insolens, and in particular cellulases supplied by Novo Industries A/A under the tradenames Carezyme®, Endo A®, other suitable cellulases are the EGIII cellulases from Trichoderma longibrachiatum; carbohydrases, including mannanase such as that described in more detail in U.S. Pat. No. 6,060,299, pectate lyase such as that described in more detail in WO 99/27083, cyclomaltodextringlucanotransferase such as that described in more detail in WO 96/33267, xyloglucanase such as that described in more detail in WO 99/02663; bleaching enzymes such as peroxidases, laccases, oxygenases (e.g. catechol 1,2 dioxygenase), lipoxygenase that is described in more detail in WO 95/26393, and non-heme haloperoxidases.

### Silicate Salt

The composition herein may further contain silicate salt. The detergent composition may contain less than about 10 wt %, from about 0 wt % to about 5 wt %, or less than about 4 wt %, or less than about 2 wt % silicate salt. It may even be preferred for the detergent about composition to be free from silicate salt. Silicate salts include water-insoluble silicates. Silicate salts include amorphous silicates and crystalline layered silicates (e.g. SKS-6). A preferred silicate salt is sodium silicate.

### Polymeric Carboxylates

The composition may contain at least about 1 wt %, at least about 2 wt %, at least about 3 wt %, at least about 4 wt %, or at least 5 wt % polymeric carboxylates. Polymeric carboxylates include: polyacrylates, preferably having a weight average molecular weight of from about 1,000 Da to about 20,000 Da; co-polymers of maleic acid and acrylic acid, preferably having a molar ratio of maleic acid monomers to acrylic acid monomers of from about 1:1 to about 1:10 and a weight average molecular weight of from about 10,000 Da to about 200,000 Da, or preferably having a molar ratio of maleic acid monomers to acrylic acid monomers of from about 0.3:1 to about 3:1 and a weight average molecular weight of from about 1,000 Da to about 50,000 Da.

### Soil Dispersant

It may also be preferred for the composition to contain a soil dispersant having the formula:

bis((C₂H₅O)(C₂H₄O)ₙ)(CH₃)—N⁺—CₓH₂ₓ—N⁺—(CH₃)-bis((C₂H₅O)(C₂H₄O)ₙ)

wherein, n=from 20 to 30, and x=from 3 to 8. Other suitable soil dispersants are sulphonate or sulphated soil dispersants having the formula:

sulphonated or sulphated bis((C₂H₅O)(C₂H₄O)ₙ)(CH₃)—N⁺—CₓH₂ₓ—N⁺—(CH₃)—bis((C₂H₅O)(C₂H₄O)ₙ)

wherein, n=from 20 to 30, and x=from 3 to 8. Preferably, the composition contains at least about 1 wt %, or at least about 2 wt %, or at least about 3 wt % soil dispersants, typically having the above described formulae.

### Inorganic Sulphate Salt

The composition herein contains from about 0 wt % to about 10 wt %, from about 0 wt % to about 8 wt %, from about 0 wt % to about 6 wt %, or from about 0 wt % to about 1 wt % inorganic sulphate salt. In one embodiment, the composition may be free from deliberately added inorganic sulphate salt. Inorganic sulphate salts include sodium sulphate, magnesium sulphate, potassium sulphate, ammonium hydrogen sulphate, ammonium sulphate, and the like. Preferably, the inorganic sulphate salt is sodium sulphate.

### Other Adjunct Components

The composition may contain adjunct components. These adjunct components include: bleach such as percarbonate and/or perborate, preferably in combination with a bleach activator such as tetraacetyl ethylene diamine (TAED), bleach activators (oxybenzene sulphonate bleach activators such as nonanoyl oxybenzene sulphonate, caprolactam bleach activators, imide bleach activators such as N-nonanoyl-N-methyl acetamide, preformed peracids such as N,N-phthaloylamino peroxycaproic acid, nonylamido peroxyadipic acid or dibenzoyl peroxide, etc.); chelants such as diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane diphosphonic acid; suds suppressing systems such as silicone based suds suppressors; brighteners; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as polycarboxylates, alkoxylated polyamines and ethoxylated ethyleneimine polymers; and anti-redeposition components such as carboxymethyl cellulose and polyesters.

### EXAMPLES

### Example 1

### Enzyme Deposition

The following laundry detergent composition was prepared (composition A):

Enzymes (Purafect 0.3 wt %, Natalase 0.5 wt %, Mannanase 0.3 wt %, Lipex 50T 0.3 wt %), sodium percarbonate 20.0 wt %, TAED 5.0 wt %, brightener 15 0.3 wt %, sodium silicate 2.0 R 2.5 wt %, EDDS 0.4 wt %, CMC 2.7 wt %, citric acid 1.6 wt %, cationic surfactant particle 6.2 wt %, LAS 14.3 wt %, polymeric carboxylate 9.4 wt %, sodium silicate 1.6 R 3.5 wt %, HEDP 1.4 wt %, sodium carbonate 12.6 wt %, zeolite 3.9 wt %, C₂₄AE₃S 5.5 wt %, moisture and miscellaneous to 100 wt %.

50 g of this detergent composition was assayed in the following enzyme deposition test. For the comparison (composition B), an additional 50 g sodium sulphate was added to composition A (high sodium sulphate composition not in accordance with the present invention).

### Enzyme Deposition Assay

Test fabrics are Terry, Knitted cotton, PW19 Polyester, Lycra (10 cm×10 cm, whiteness swatches). The experiment was carried under both hard water (Borehole water, ˜30.1 gpg) and soft water (˜0.4 gpg). Four repetitions of each product were carried out. Test was run over 10 cycles. Fabric was taken before washed, and then test fabrics removed after cycles 1, 5 and 10 and wrapped in foil, inserted into a refrigerator after drying.

### Method to Determine the Enzyme Content of Fabric Extracts

Enzyme protein on fabric is determined by the modified double antibody sandwich ELISA (Enzyme Linked Immunosorbent Assay) technique.

### Preparation of Solutions:

### (1) Capture Antibody Buffer

Capture antibody buffer was prepared by making a solution of 1.51 g sodium carbonate (Na₂CO₃) and 2.93 g sodium bicarbonate (NaHCO₃) in 1 L of deionised water. The pH of the solution was 9.6+/−0.2.

### (2) Wash Buffer

Wash Buffer was prepared by dissolving 29.22 g sodium chloride (NaCl), 1.86 g Trizma base (THAM, TRIS) and 1 g Bovine Serum Albumin (BSA) in 800 ml of deionised water. The pH of the solution was adjusted to 8.0. Thereto was added 0.5 ml of Tween 20 (Practical grade), and the volume was adjusted to 1 L with deionised water.

### (3) Citrate-Phosphate Buffer

Citrate-Phosphate buffer was prepared by dissolving 7.30 g of citric acid monohydrate (C₆H₈O₇H₂O) and 23.87 g sodium phosphate (Na₂HPO₄ 12H₂O) in 1 L of deionised water. The pH was 5.0+/−0.2.

### (4) Blocking Buffer

Blocking Buffer was prepared by dissolving 2.0 g of Bovine Serum Albumin (BSA) in 100 ml of deionised water or by dissolving 1 ml of Meggablock (ex Bionostics Ltd., UK) in 500 ml of deionised water.

### (5) Sample Preparation Solution

Sample Preparation Solution was prepared by dissolving 0.93 g Trizma base, 4.96 g sodium thiosulphate pentahydrate (Na₂S₂O₃ 5H₂O), 0.147 g calcium chloride dihydrate (CaCl₂ 2H₂O), 29.22 g sodium chloride (NaCl) and 1.0 g sodium azide (NaN₃) in 800 ml of deionised water. Thereto was added 1 g Bovine Serum Albumin (BSA) and the solution was adjusted to pH 8.0 by adding hydrochloric acid (HCl). Thereto was added 1.0 ml of Tween 20, and then the solution was adjusted to 1 L with deionised water.

### (6) OPD Substrate Solution

OPD substrate solution was prepared by dissolving 30 mg (one tablet) of Dako OPD in 45 ml of Citrate-Phosphate buffer in an amber vial. Just before using, thereto was added 25 μl of 30% hydrogen peroxide (H₂O₂) and the solution was kept away from light.

### (7) Rabbit Capture Antibody

Rabbit capture antibody was prepared by diluting 11 μl of Rabbit anti-enzyme protein serum with 11 ml of capture antibody buffer.

### (8) Guinea Pig or Goat Detecting Antibody

Guinea Pig or Goat detecting antibody was prepared by diluting 11 μl of Guinea Pig or Goat anti-enzyme protein serum with 11 ml of BSA blocking buffer.

### (9) Guinea Pig or Goat Peroxidase

Guinea Pig or Goat Peroxidase was prepared by diluting 11 μl of Guinea Pig or Goat peroxidise with 11 ml of BSA blocking buffer.

### Preparation and Analysis of Samples

A 96 well plate was prepared by adding 100 μl of Rabbit capture antibody to each well of the plate. The plate was stored at 4° C. for 16 hours. The plate was emptied and rinsed with Wash Buffer. 200 μl of Blocking Buffer was added and it was allowed to stand for 60 minutes. The plate was emptied and rinsed with Wash Buffer.

The fabric was curled into a 50 ml centrifuge tube and to the tube was added 25 ml of Sample Preparation Solution at 21+/−1° C. The tube was capped and spinned on a sample rotator at 30+/−5 rpm for 30 minutes.

For each sample to be analysed was added 100 μl of the extracted Sample Preparation Solution to two wells in the 96 well plate. The plate was placed on an incubator/shaker for 40 minutes at 37+/−1° C. The plate was emptied and rinsed with wash buffer.

100 μl of Guinea Pig or Goat detecting antibody was added to each well of the plate. The plate was placed on an incubator/shaker for 40 minutes at 37+/−1° C. The plate was emptied and rinsed with Wash Buffer.

100 μl of Guinea Pig or Goat Peroxidise solution was added to each well of the plate. The plate was placed on an incubator/shaker for 40 minutes at 37+/−1° C. The plate was emptied and rinsed with wash buffer.

Each well was washed three times with Citrate-Phosphate buffer.

100 μl of OPD substrate solution was added to each well. The plate was placed on the incubator/shaker until a suitable colour has developed, typically 1-20 minutes. The reaction was terminated by adding 100 μl 1M H₂SO₄ (sulphuric acid) to each well of the plate. The colour changed from yellow to orange.

The absorbance of each well was measured at 492 nm and 620 nm.

A calibration curve of net absorbance versus concentration in ng/ml protein for the standards was constructed. Using the calibration curve read off the concentration of each unknown sample using the measured absorbance.

The results are shown below.

| | |
|---|---|
| Composition A | Composition B |
| Enzyme deposition | Enzyme deposition |
| (ng/g fabric) | (ng/g fabric) |

| Cycles | hard water | soft water | hard water | soft water |
|---|---|---|---|---|
| 1 | 29 | 24 | 3 | 7 |
| 5 | 57 | 71 | 34 | 22 |
| 10 | 107 | 44 | 16 | 21 |

From the experiment above, a significant increase was seen in enzyme deposition was observed for composition A compared to composition B, both in soft water and hard water environment.

### Example 2

### Laundry Detergent Composition

A granular laundry composition in accordance with the present invention was prepared.

| Ingredient | Composition A | | Composition B | | Composition C | | Composition D | |
|---|---|---|---|---|---|---|---|---|
| C10 non-ionic | 0.4 | wt % | 0.4 | wt % | 0.4 | wt % | 0.4 | wt % |
| C₁₁₋₁₃ alkyl benzene sulphonate | 15.0 | wt % | 14.0 | wt % | 10.0 | wt % | 16.0 | wt % |
| (LAS) | | | | | | | | |
| Sodium Silicate | 2.0 | wt % | 6.0 | wt % | 3.5 | wt % | 0.0 | wt % |
| Zeolite A | 6.0 | wt % | 5.0 | wt % | 0.0 | wt % | 0.0 | wt % |
| Sodium carbonate | 25.0 | wt % | 20.0 | wt % | 30.0 | wt % | 40.0 | wt % |
| Sodium Ethylene Diamine | 0.3 | wt % | 0.4 | wt % | 0.5 | wt % | 0.6 | wt % |
| Disuccinate | | | | | | | | |
| Tripolyphosphate | 0.2 | wt % | 0.5 | wt % | 0.4 | wt % | 0.0 | wt % |
| Sodium Sulphate | 0.0 | wt % | 0.0 | wt % | 0.0 | wt % | 0.0 | wt % |
| Sodium | 1.5 | wt % | 1.7 | wt % | 1.3 | wt % | 1.4 | wt % |
| nonanoyloxybenzenesulfonate | | | | | | | | |
| Percarbonate | 20.0 | wt % | 25.0 | wt % | 25.0 | wt % | 20.0 | wt % |
| Enzymes (Amylase, Cellulase, | 2.0 | wt % | 1.5 | wt % | 1.0 | wt % | 0.5 | wt % |
| Lipex, Mannanase, Protease) | | | | | | | | |
| Carboxymethyl cellulose (CMC) | 1.0 | wt % | 2.0 | wt % | 2.5 | wt % | 1.5 | wt % |
| Copolymer of maleic acid and | 10.0 | wt % | 5.0 | wt % | 6.0 | wt % | 7.0 | wt % |
| acrylic acid (MA/AA) | | | | | | | | |
| Tetraacetylethylenediamine (TAED) | 5.0 | wt % | 5.0 | wt % | 7.0 | wt % | 1.0 | wt % |
| C₁₂₋₁₄ Alkyl 1-Ethoxy Sulfate | 4.0 | wt % | 7.0 | wt % | 6.0 | wt % | 5.0 | wt % |
| Moisture and Miscellaneous: | to 100 | wt % | to 100 | wt % | to 100 | wt % | to 100 | wt % |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid laundry detersive composition comprising:
(i) from about 1 wt % to about 60 wt % detersive surfactant;
(ii) from about 0 wt % to about 10 wt % zeolite builder;
(iii) from about 0 wt % to about 10 wt % phosphate builder;
(iv) from about 0 wt % to about 10 wt % inorganic sulphate salt; and
(v) balance detergent ingredients.

2. A composition of claim 1, comprising from about 1 wt % to about 9 wt % inorganic sulphate salt.

3. A composition of claim 1, comprising substantially no inorganic sulphate salt.

4. A composition of claim 1, wherein the detersive surfactant is an anionic surfactant.

5. A composition of claim 4, comprising from about 4 wt % to about 40 wt % anionic surfactant.

6. A composition of claim 1, wherein the detersive surfactant is a non-ionic surfactant.

7. A composition of claim 1, wherein the composition is a granular laundry detersive composition.

8. A composition of claim 1, further comprising an enzyme.

9. A composition of claim 1, wherein the inorganic sulphate salt is sodium sulphate.
